(19) United States
(12) Patent Application Publication
(10) Pub. No.: US 2012/0099069 A1
(43) Pub. Date: Apr. 26, 2012

(54) DISPLAY DEVICE AND ELECTRONIC APPARATUS HAVING THE SAME

(75) Inventor: Masahiro Yoshiga, Kobe (JP)

(73) Assignee: CHIMEI INNOLUX CORPORATION, Miao-Li County (TW)

(21) Appl. No.: 13/216,595

(22) Filed: Aug. 24, 2011

(30) Foreign Application Priority Data
Oct. 25, 2010 (JP) 2010-238668

(51) Int. Cl. G02F 1/1343

(52) U.S. Cl. 349/143

(57) ABSTRACT

A display device comprises a plurality of pixels, arranged in a matrix having columns and rows, and a plurality of signal lines, provided in pixel columns or pixel rows. Each of the plurality of pixels comprises a pixel electrode, a first and a second switching element, turned on and off simultaneously and arranged in serial between the pixel electrode and a signal line correspondingly connected to a pixel column or a pixel row of the pixel, and a resistance element, connected from a position between the first and the second switching element to a predetermined constant voltage. A resistance value of the resistance element is larger than turned-on resistance values of the first and the second switching element and smaller than turned-off resistance values of the first and the second switching element. The predetermined constant voltage equals a center voltage of a signal voltage applied to the signal line.

### CROSS REFERENCE TO RELATED APPLICATIONS

This Application claims priority of Japan Patent Application No. 2010-238668, filed on Oct. 25, 2010, the entirety of which is incorporated by reference herein.

### BACKGROUND OF THE INVENTION

1. Field of the Invention

The invention relates to a plurality of pixels arranged in a matrix having columns and rows, a display device having a plurality of signal lines provided in pixel columns or pixel rows, and an electronic apparatus having the same.

2. Description of the Related Art

In a display device having a plurality of pixels arranged in a matrix having columns and rows, each pixel comprises a switching element provided at an intersection of a signal line (also known as source line) and a scan line (also known as gate line). Each pixel further comprises a pixel electrode formed on a substrate where the switching element is also formed and a common electrode formed on a substrate opposite to the pixel electrode. The common electrode is connected to a constant current source which is shared by all pixels. A switching element is turned on according to a scan signal on a gate line correspondingly connected to a pixel column in which the switching element is. The duration when the switching element is turned on is generally known as a “scanning period”. During the scanning period, a pixel electrode is connected to a source line correspondingly connected to a pixel row in which the pixel electrode is via a switching element, and a signal voltage is applied to the pixel electrode. Therefore, there's a potential difference between the pixel electrode and the common electrode, driving a display element provided between the pixel electrode and the common electrode. For example, if the display element is liquid crystal, the orientation of the liquid crystal alignment changes in accordance with the potential difference between the pixel electrode and the common electrode, and therefore quantities of transmitted light or reflected light also change, which enables displaying.

Typically a thin film transistor (TFT) is used as a switching element. When using a TFT, leakage current due to light irradiation can be a problem. When light irradiates a TFT, charges stored in the display element and a holding capacitor arranged in parallel with the display element still leak to the signal line even though the TFT is off, and therefore it causes crosstalk.

In view of this, inventions that intend to reduce photo leakage current have been disclosed, for example, Japan Patent Application Publication No. 2005-338285 (Patent literature 1) and Japan Patent Application Publication No. 2003-215536 (Patent literature 2).

[Patent literature 1] Japan Patent Application Publication No. 2005-338285

[Patent literature 2] Japan Patent Application Publication No. 2003-215536

### BRIEF SUMMARY OF THE INVENTION

### Problem to be Solved

Nevertheless, prior art solutions still have difficulties in completely restraining photo leakage current. Even though prior art solutions can completely restrain photo leakage current, there are still problems concerning complicated circuit structures and complicated control of circuit structures.

In view of the difficulties of the prior art, the purpose of the invention is to provide a display device and an electronic apparatus having the same to restrain photo leakage current without complicating the circuit structure and control of the circuit.

### Solution

For the purpose described above, the invention provides a display device, comprising: a plurality of pixels, arranged in a matrix form having columns and rows; and a plurality of signal lines, provided in pixel columns or pixel rows of the plurality of pixels, wherein each of the plurality of pixels comprises: a pixel electrode; a first and a second switching element, turned on and off simultaneously, arranged in serial between the pixel electrode and a signal line correspondingly connected to a pixel column or a pixel row of the pixel; and a resistance element, connected from a position between the first and the second switching element to a predetermined constant voltage; wherein a resistance value of the resistance element is larger than turned-on resistance values of the first and the second switching element and is smaller than turned-off resistance values of the first and the second switching element; wherein the predetermined constant voltage is equal to a center voltage of a signal voltage applied to the signal line.

According to this, the invention provides a display device that can restrain photo leakage current without complicating the circuit structure and the control of the circuit.

In one embodiment, the predetermined voltage is provided in a side opposite to the pixel electrode through a display element.

In one embodiment, the resistance element is a third switching element which is turned-off when the first and the second switching element are turned-on, and is turned-on when the first and the second switching element are turned-off. For example, the first and the second switching element are N-type thin-film transistors, and the third switching element is a P-type thin-film transistor. Alternately, the first and the second switching element are P-type thin-film transistors, and the third switching element is an N-type thin-film transistor.

Display devices implemented according to embodiments of the invention are, for example, television, laptop type or desktop type personal computer (PC), mobile phone, personal digital assistant (PDA), car navigation system, portable game machine, or electronic apparatuses, such as Aurora Vision, display devices etc. to provide images to a user.

### Effect

According to embodiments of the disclosure, the invention provides a display device and an electronic apparatus having the same to restrain photo leakage current without complicating the circuit structure and the control of the circuit.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a block diagram of a structure of a display device according to an embodiment of the invention;

FIG. 2 is a circuit diagram of a conventional pixel structure in prior arts;

FIG. 3 is a circuit diagram of a pixel structure according to an embodiment of the invention;

FIG. 4 is a circuit diagram of a modification of the pixel structure in FIG. 3;

FIG. 5 is a block diagram of comparisons of crosstalk values between a display device having the pixel circuit in FIG. 4 and a prior art display device;

FIGS. 6(a) and 6(b) illustrate a method of calculating crosstalk values;

FIG. 7 is a block diagram of an electronic apparatus according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

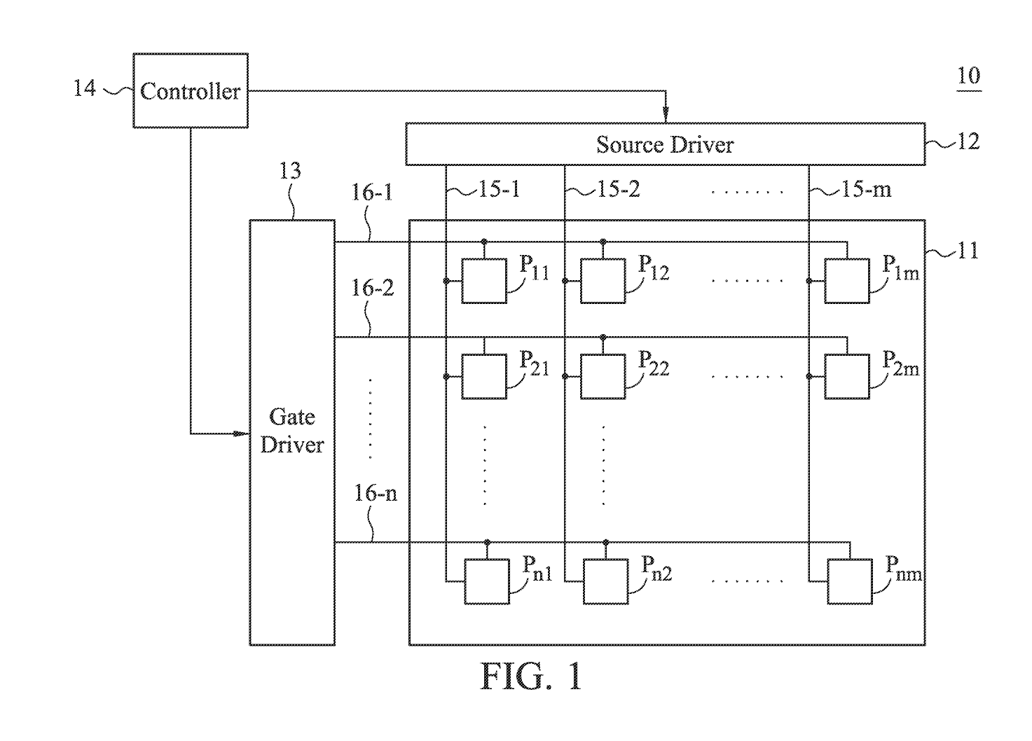

FIG. 1 is a block diagram of a structure of a display device according to an embodiment of the invention. The display device 10 in FIG. 1 comprises a display panel 11, a source driver 12, a gate driver 13 and a controller 14.

The display panel 11 comprises a plurality of pixels P₁₁˜Pₙₘ (n and m are integers) arranged in a matrix form having columns and rows. The display panel 11 further comprises a plurality of source lines 15-1˜15-m provided in pixel rows or pixel columns and a plurality of gate lines 16-1˜16-m provided in pixel columns or pixel rows perpendicular to source lines 15-1˜15-m.

The source driver 12, a signal line driving circuit that drives signal lines 15-1˜15-m according to image data signals, applies signal voltages to each of pixels P₁₁˜Pₙₘ through source lines 15-1˜15-m. The gate driver 13, a scan line driving circuit that drives gate lines 16-1˜16-m sequentially, controls application of signal voltages to each of pixels P₁₁˜Pₙₘ through source lines 15-1˜15-m. The gate driver 13 selects pixels in columns according to a scan method such as an interlaced or progressive scan method, and signal voltages are applied to selected pixels through signal lines. For example, a liquid crystal display device uses changes in orientation of alignment of liquid crystal molecules caused by applied signal voltages to polarize back light or ambient light (reflected light) so as to display images.

The controller 14 synchronizes the source driver 12 and the gate driver 13 and controls behaviors thereof.

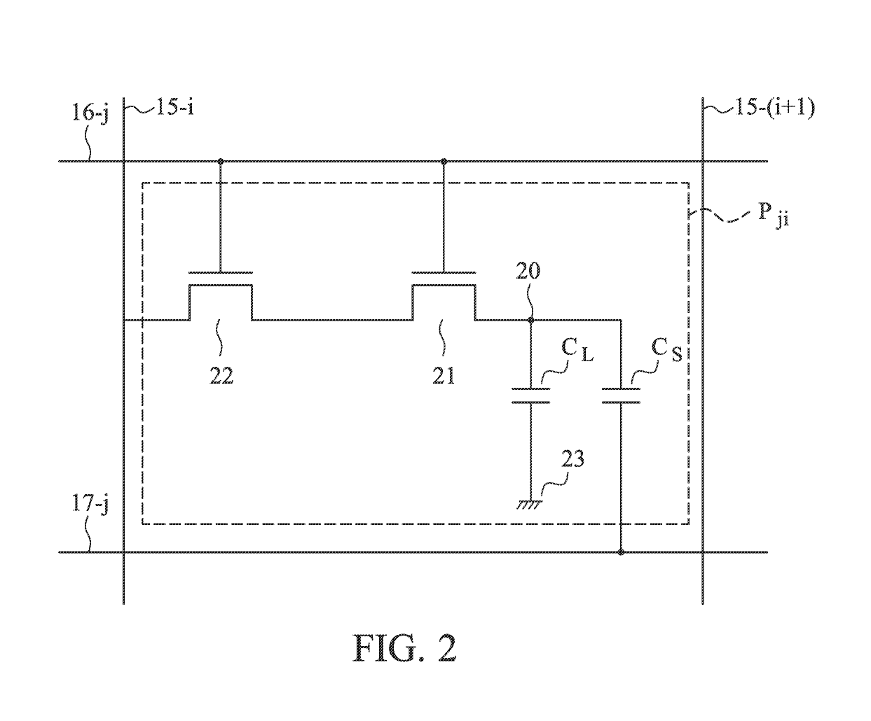

FIG. 2 is a circuit diagram of a conventional pixel structure in prior arts.

Pixel Pⱼᵢ (i and j are integers, 1≦i≦m, and 1≦j≦n) is arranged at an intersection of a source line 15-i correspondingly connected to the i-th row in which the pixel is and a gate line 16-j correspondingly connected to the j-th column in which the pixel is.

The pixel Pⱼᵢ comprises a pixel electrode 20, a first switching element 21 and a second switching element 22 that are formed on a substrate where the pixel electrode 20 is also formed, and a common electrode 23 is formed on a substrate opposite to the pixel electrode 20 through a display element such as a liquid crystal display element. For understanding, in FIG. 2, the liquid crystal display element C_{L} is represented by a capacitor between the pixel electrode 20 and the common electrode 23. The common electrode 23 is connected to a constant current source which is shared by all pixels P₁₁˜Pₙₘ.

The first switching element 21 and the second switching element 22, switching elements that have the same switching characteristics, are connected in serial between the pixel electrode 20 and the source line 15-i. Control ends of the first switching element 21 and the second switching element 22 are connected to the gate line 16-j. The first switching element 21 and the second switching element 22 turns on simultaneously according to scan signals on the gate line 16-j. For example, the first switching element 21 and the second switching element 22 are N-type or P-type thin-film transistors (TFT). In FIG. 2, the first switching element 21 and the second switching element 22 are represented as N-type TFTs.

Furthermore, the pixel Pⱼᵢ comprises a holding capacitor C_{S}. When a scanning period ends and the next scanning period has not arrived yet. That is, during one period of rewriting image data, the holding capacitor C_{S} maintains charges of the signal voltage applied to the pixel electrode 20. In order to maintain charges of the signal voltage, the holding capacitor C_{S} is arranged between a C_{S} line 17-j in parallel with the gate line 16-j and the pixel electrode 20. Alternatively, the holding capacitor C_{S} is replaced by the C_{S} line 17-j and is connected to the common electrode 23.

The first switching element 21 and the second switching element 22 are designed to make the pixel electrode 20 connect to the source line 15-i during a scanning period in which each column of pixels is selected. Having at least one of the first switching element 21 and the second switching element 22 is sufficient for this design. However, during a non-scanning period in which columns of pixels are not selected, resistance between the pixel electrode 20 and the source line 15-i is large. Therefore, in order to restrain the photo leakage current that flows to the source line 15-i through the first switching element 21 and the second switching element 22 in a turned-off state, conventionally 2 switching elements are provided in serial between the pixel electrode 20 and the source line 15-i.

Nevertheless, it still can't completely restrain the photo leakage current. As influence, if intensity of light irradiating the first switching element 21 and the second switching element 22 is larger, the effect of crosstalk is more obvious.

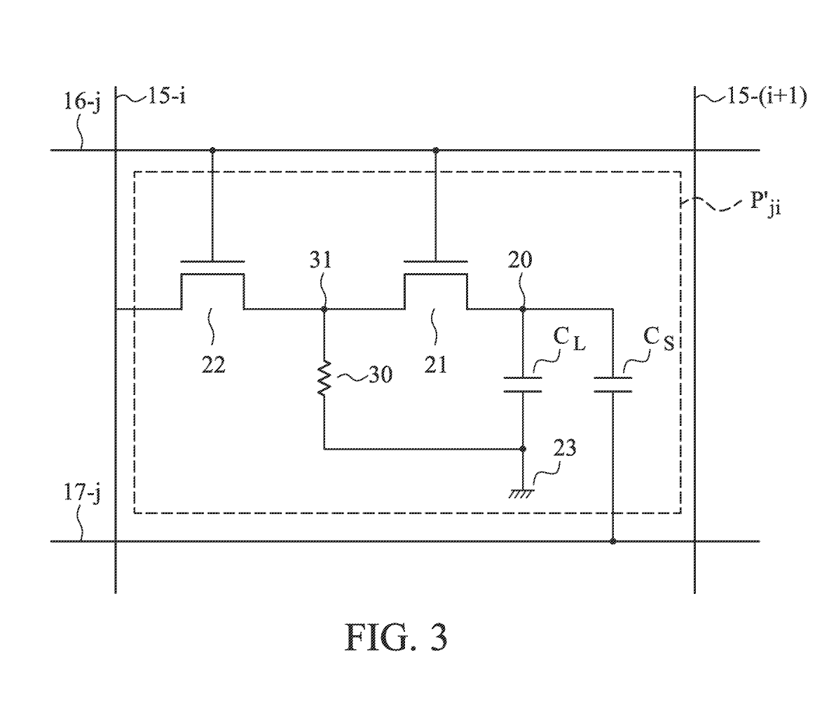

FIG. 3 is a circuit diagram of a pixel structure according to an embodiment of the invention

The difference between pixel P′ⱼᵢ in FIG. 3 and the pixel Pⱼᵢ in FIG. 2 is that the pixel P′ⱼᵢ further comprises a resistance element 30. The resistance element 30 comprises a first end connected to a connection point 31 between the first switching element 21 and the second switching element 22 and a second end connected to the common electrode 23. A resistance value of the resistance element 30 is larger than turned-on resistance values of the first switching element 21 and the second switching element 22 and is smaller than turned-off resistance values of the first switching element 21 and the second switching element 22.

Therefore, the photo leakage current occurring when the first switching element 21 and the second switching element 22 are turned-off flows from the pixel electrode 20 to the common electrode 31 through the first switching element 21 and the resistance element 30, and the photo leakage current doesn't leak to the source line 15-i. As a consequence, crosstalk is prevented. Furthermore, at this moment, terminal voltage of the display element C_{L} drops continuously without relation to the polarity, therefore, it is expected that flicker is improved.

On the other hand, during the scanning period in which the first switching element 21 and the second switching element 22 are turned-on, the current flows from the source line 15-i to the pixel electrode 20 through the first switching element 21 and the second switching element 22. Accordingly, the resistance element 30 which is added to the pixel circuit doesn't affect the behavior of the pixel circuit during the scanning period.

In this embodiment, a second end of the resistance element 30 is connected to the common electrode 23. Generally, the center voltage of the source line 15-i is 0 volt and the range of variation is ±5 volts, and the common electrode is grounded (that is, 0 volt). The second end of the resistance element 30 is not limited to be connected to the common electrode 23. The second end can also be connected to a constant current source having a voltage value equal to the center voltage of the signal voltage applied to the source line 15-i.

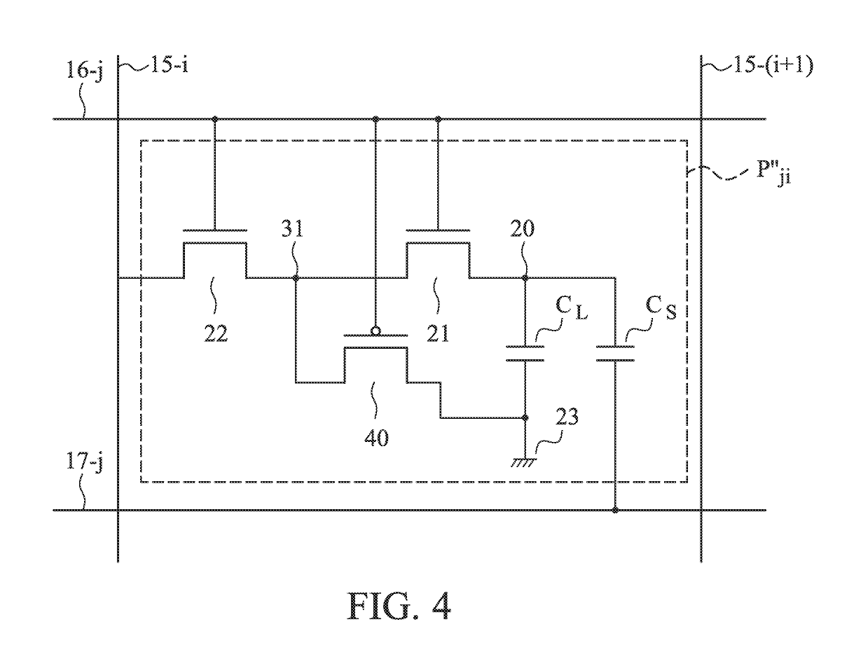

FIG. 4 is a circuit diagram of a modification of the pixel structure in FIG. 3.

The difference between pixel P″ⱼᵢ in FIG. 4 and the P′ⱼᵢ in FIG. 3 is that the pixel P″ⱼᵢ in FIG. 4 uses a switching element 40 as the resistance element 30. The switching element 40 is provided between the connection point 31 which is between the first switching element 21 and the second switching element 22 and the common electrode 23. The control end of the switching element 40 is connected to the gate line 16-j. However, switching characteristics of the switching element 40 is opposite to switching characteristics of the first switching element 21 and the second switching element 22. The switching element 40 is turned-off when the first switching element 21 and the second switching element 22 are turned-on, and the switching element 40 is turned-on when the first switching element 21 and the second switching element 22 are turned-off. For example, as shown in FIG. 4, when the first switching element 21 and the second switching element 22 are N-type thin-film transistors, the switching element 40 is a P-type thin-film transistor. Alternatively, when the first switching element 21 and the second switching element 22 are P-type thin-film transistors, the switching element 40 is an N-type thin-film transistor.

Accordingly, the photo leakage current occurring when the first switching element 21 and the second switching element 22 are not turned-on flows from the pixel electrode 20 to the common electrode 23 through the first switching element 21 and the switching element 40, and the photo leakage current doesn't leak to the source line 15-i. As a consequence, crosstalk is prevented. Furthermore, at this moment, terminal voltage of the display element C_{L} drops continuously without relation to the polarity, therefore, it is expected that the flicker is improved.

On the other hand, during the scanning period in which the first switching element 21 and the second switching element 22 are turned-on, the current flows from the source line 15-i to the pixel electrode 20 through the first switching element 21 and the second switching element 22. Accordingly, the switching element 40 which is added to the pixel circuit doesn't affect behaviors of the pixel circuit during the scanning period.

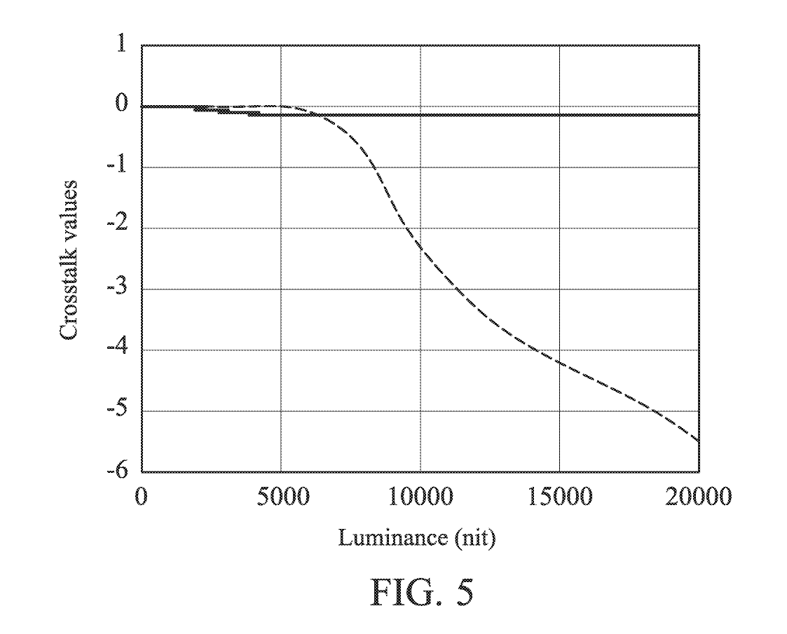

FIG. 5 is a block diagram of comparisons of crosstalk values between a display device having the pixel circuit in FIG. 4 and a prior art display device. In this graph, the vertical axis represents crosstalk values, and the horizontal axis represents luminance of back light.

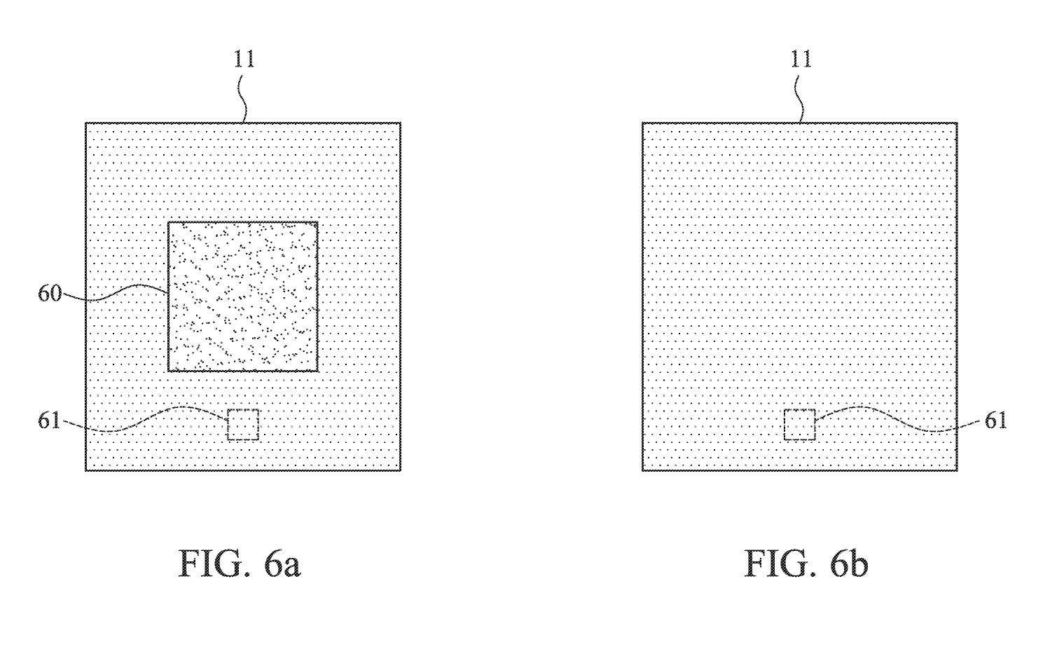

Crosstalk values are calculated by utilizing display patterns as shown in FIGS. 6 (a) and 6 (b). Display patterns in FIGS. 6 (a) and 6 (b) take normally black as example, wherein normally black is a black color that is displayed when no voltage is applied to the pixel electrode. Generally, FIG. 6 (a) is known as a window pattern. That is, the display panel 11 displays a black window 60 in the center of the half-tone background. FIG. 6 (b) is generally known as a raster pattern. That is, the entire display panel 11 displays the half-tone background. In the case of displaying the window pattern, luminance L_{w} of any pixel 61 located under the black window 60 is measured. Similarly, in the case of displaying the raster pattern, luminance L_{ref} of the same pixel 61 is measured. The luminance L_{ref} of the pixel 61 in the case of displaying the raster pattern is taken as a reference value. Crosstalk value is a percentage value representing the difference between the luminance L_{w} and the reference value L_{ref} compared to the reference value L_{ref}:

Crosstalk value (%)=((L_{w}−L_{ref})/L_{ref})×100.

In this way, the influence to other pixels in the direction vertical to pixels that display the black window 60 can be estimated.

In FIG. 5, the real line represents crosstalk values of a display device having the pixel circuit in FIG. 4, and the broken line represents crosstalk values of a display device according to prior arts. As shown in the graph, crosstalk values of a display device according to prior arts increase as luminance of back light increases. On the other hand, crosstalk values of a display device having the pixel circuit in FIG. 4 roughly holds at 0 no mater what value of luminance of back light is. Therefore, it is proved that embodiments of the invention are able to restrain photo leakage current without complicating the circuit structure and the control of the circuit.

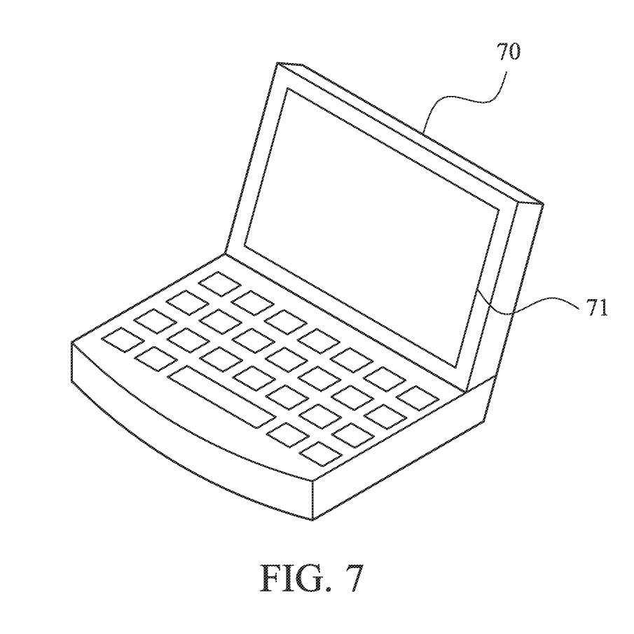

FIG. 7 is a block diagram of an electronic apparatus according to an embodiment of the invention. The electronic apparatus 70 in FIG. 7 is represented as a laptop type personal computer (PC), but the electronic apparatus 70 can also be other electronic apparatuses, for example, televisions, mobile phones, watches, personal digital assistants (PDAs), desktop type PCs, car navigation systems, portable game machines, or Aurora Visions etc.

The laptop type PC 70 comprises a display device 71, comprising a display panel that can display images from data. The display device 71, a display device that comprises a pixel circuit as shown in FIG. 3 or FIG. 4, restrains the photo leakage current and therefore restrains crosstalk.

While the invention has been described by way of example and in terms of preferred embodiment, it is to be understood that the invention is not limited thereto. To the contrary, it is intended to cover various modifications and similar arrangements (as be apparent to those skilled in the art). Therefore, the scope of the appended claims should be accorded the broadest interpretation so as to encompass all such modifications and similar arrangements.

What is claimed is:

1. A display device, comprising:
a plurality of pixels, arranged in a matrix form having columns and rows; and
a plurality of signal lines, provided in pixel columns or pixel rows of the plurality of pixels,
wherein each of the plurality of pixels comprises:
a pixel electrode;
a first and a second switching element, turned on and off simultaneously, arranged in serial between the pixel electrode and a signal line correspondingly connected to a pixel column or a pixel row of the pixel; and
a resistance element, connected from a position between the first and the second switching element to a predetermined constant voltage,
wherein a resistance value of the resistance element is larger than turned-on resistance values of the first and the second switching element and is smaller than turned-off resistance values of the first and the second switching element, and
wherein the predetermined constant voltage is equal to a center voltage of a signal voltage applied to the signal line.

2. The display device as claimed in claim 1, wherein the predetermined voltage is provided in a side opposite to the pixel electrode through a display element and is a voltage of a common electrode shared by all of the plurality of pixels.

3. The display device as claimed in claim 2, wherein the resistance element comprises a first end connected to the position between the first and the second switching element and a second end connected to the common electrode.

4. The display device as claimed in claim 3, wherein the resistance element is a resistor.

5. The display device as claimed in claim 3, wherein the resistance element is a third switching element which is turned-off when the first and the second switching element are turned-on, and is turned-on when the first and the second switching element are turned-off.

6. The display device as claimed in claim 5, wherein the first and the second switching element are N-type thin-film transistors, and the third switching element is a P-type thin-film transistor.

7. The display device as claimed in claim 5, wherein the first and the second switching element are P-type thin-film transistors, and the third switching element is an N-type thin-film transistor.

8. The display device as claimed in claim 2, wherein the display element is liquid crystal.

9. An electronic apparatus, comprising the display device as claimed in claim 1.

10. An electronic apparatus, comprising the display device as claimed in claim 2.

11. An electronic apparatus, comprising the display device as claimed in claim 3.

12. An electronic apparatus, comprising the display device as claimed in claim 4.

13. An electronic apparatus, comprising the display device as claimed in claim 5.

14. An electronic apparatus, comprising the display device as claimed in claim 6.

15. An electronic apparatus, comprising the display device as claimed in claim 7.

16. An electronic apparatus, comprising the display device as claimed in claim 8.
